(19) United States
(12) Patent Application Publication
(10) Pub. No.: US 2005/0148382 A1
(43) Pub. Date: Jul. 7, 2005

(54) Gaming Device with Bingo Multiplier Bonus

(75) Inventor: John Fox, Omaha, NE (US)

Correspondence Address: JOHN FOX, 3902 Q STREET, OMAHA, NE, 68107, US

(73) Assignee: AMERICAN AMUSEMENTS CO, Omaha, NE (US)

(21) Appl. No.: 10/709,195

(22) Filed: Apr. 20, 2004

Related U.S. Application Data
(60) Provisional application No. 60/481,832, filed on Dec. 26, 2003.

(51) Int. Cl. A63F 13/00

(52) U.S. Cl. 463/19

(57) ABSTRACT

A method and device for gaming, in which a primary game is played toward a non-traditional winning outcome, achieved via assignment of multiplier values to each spot on the bingo card (decided in more detail herein). The multiplier bonus differs from the traditional game bingo as follows; by adding the new types of possible winning outcomes based on the multiplied total of matching spots on the bingo card or cards, in addition to or in place of, traditional bingo pattern winning outcomes. These devices may utilize “progressive” awards, allowing players to compete against each other for larger awards. Additionally, multiple levels of multiplier bonus awards may be offered, with each level based on the amount of the initial wager.

### REFERENCE TO PRIOR PROVISIONAL PATENT

This invention was submitted for a provisional patent, electronically, by the same inventor, John Fox, under the title “Bingo Multiplier” in provisional application number 60/481832 on the 26th of Dec. 2003.

References Cited

U.S Patent Documents
6,364,313 April, 2002 Moody 463/16
6,338,678 January, 2002 Seelig et al. 273/138
6,309,300 October, 2001 Glavich 463/26
6,139,013 October, 2000 Pierce et al. 463/20
6,012,982 January, 2000 Piechowiak et al. 463/16
5,685,541 November, 1997 Lovell, Sr. 463/20
5,647,798 July, 1997 Falciglia 463/19
5,639,089 June, 1997 Matsumoto et al. 463/19
5,639,088 June, 1997 Schneider et al. 463/13.
5,624,119 April, 1997 Leake 463/19
5,613,910 March, 1997 Hamano 463/19
5,393,057 February, 1995 Marnell, II 463/20.
4,611,811 September, 1986 Haase 463/19

Foreign Patent Documents
9-19534 September, 1997JP.

### BACKGROUND OF INVENTION

In the game of bingo, each player is provided with a card that includes a matrix of five rows and five columns defining twenty-five grid squares. The left-most column is labeled “B”, the second column “I”, the third column “N”, the fourth column “G” and the right-most column “O”. Traditionally, each grid square, with the exception of the “free” center grid square, is labeled with a number in the range of 1 to 75. The grid squares in the “B” column use the numbers in the range of 1 to 15. The squares in the “I” column use the numbers in the range of 16 to 30. The grid squares in the “N” column, except the center square, use the numbers in the range of 31 to 45. The grid squares in the “G” column use the numbers in the range of 46 to 60. The grid squares in the “O” column use the numbers in the range of 61 to 75. Each grid square is defined by the combination of a letter identifying the column and a number. As a caller randomly calls combinations of columns and numbers, each player indicates which of that player's grid squares had been called, either through markings in the grid squares or placing items on the squares. The first person to achieve a pre-determined pattern of called grid squares is the winner of that game. Examples of patterns include: one straight line, two straight lines; the entire card, the border of the grid, etc.

The game of bingo has developed into a substantial form of gambling in which players purchase cards and winners are rewarded with prizes, frequently in the form of cash. The game is simple enough for almost anyone to play and it gives the players a feeling of involvement in the game of chance. In a casino environment it is generally desirable to have the bingo games achieve a winner as frequently as possible so that more games can be played in a shorter time period. More games being played means that there will be more winners. Players who win periodically are more likely to continue playing. More games also mean more revenue for the house.

Various efforts have been made to speed up the games, other than just calling numbers faster. For example, some game cards, such as those sold under the trademark “Double Action Bingo” from Bonus Games Inc., include two numbers in each square. In essence, two separate game cards have been combined into a single game card so that two games can been played at one time. Each game card has the opportunity to be a winner in two separate games called from the same set of numbers. Nevertheless, the basic game is still the same as traditional bingo.

It is an object of the invention to provide a bingo game that provides a winner with a specific number of called squares with the added incentive of receiving a multiplier bonus award.

The primary purpose of playing any game is to win the game. While a player may initially find enjoyment in trying to win a particular game, tedium sets in if no further stimulus is offered to entertain the player. Accordingly, several games have been developed that offer a “bonus” game for attaining a particular outcome, allowing the player the prospect of engaging in a different gaming proposition. Many bonus games, however, simply consist of playing a revised version of the initial game, which does nothing to relieve tedium produced by the initial game. Additionally, “progressive” award games are offered by some developers, offering awards dependent on the number of players engaged in the participating machines. These add the excitement of obtaining a larger award, but are available only to players who employ maximum wagers. Such propositions are not stimulating to players who choose to play consistently, but with lower stakes.

### FIELD OF THE INVENTION

The following invention is generally related to instrumentalities and methodologies in bingo gaming devices. More specifically, the invention is directed to a bingo gaming device, having or not having a winning outcome in which the player is rewarded, and a second triggering outcome allowing the player to receive a payout award. Such a gaming device may be utilized with multiple levels of “progressive” awards, with the level of the available multipliers based on the amount of the initial wager. As a consequence, awarding of credits may be defined by a plurality of levels of progressive awards, wherein each level is dependent on the number of gaming propositions occurring simultaneously.

### BRIEF DESCRIPTION OF DRAWINGS

FIG. 1 is an example bingo card comprised of a 5×5 row-and-column (RXC) matrix.

FIG. 2 is an example bingo card of FIG. 1, containing randomly chosen numbers comprising the first indicia.

FIG. 3 is the example bingo card of FIG. 2, but also displays example pre-assigned bonus multipliers.

FIG. 4 displays an example ball draw, comprising the second indicia.

FIG. 5 displays an example payable with award amounts.

FIG. 6 displays an example game, resulting in a bingo bonus value total of 105 derived from Bingo card of FIG. 1 with first indicia of FIG. 2 pre-assigned bonus multiplier vales of FIG. 3, the random selection of second indicia of FIG. 4 with the Payable of FIG. 5, resulting in a winning award to the player of 1×, based on the payable of FIG. 5.

### DETAILED DESCRIPTION

### SUMMARY OF THE INVENTION

Accordingly, it is a primary object of the present invention to provide a new and novel device and method for gaming, in which a player has the opportunity and chance at success via the use of new non-patterned based winning outcomes.

It is a further object of the present invention to provide a device and method as characterized above which provides a player with the prospect of engaging in different types of gaining propositions in one gaming session.

It is a further object of the present invention to provide a device and method as characterized above to offer a player the opportunity to effectively compete against the device for a larger award.

It is a further object of the present invention to provide a device and method as characterized above that allows participation in “progressive” awards even if the player does not have a maximum wager enabled.

Viewed from a first vantage point, it is an object of the present invention to provide a method for playing bingo, the steps including: receiving a wager to enable the gaming device, enabling a primary display, displaying at least one possible outcome leading to a bonus event, wherein the bonus event is defined by a randomly numbered grid, oriented in an row-and-column (RXC) matrix, randomly generated indicia, first comparison means to determine whether said randomly generated indicia match any positions on said randomly numbered grid, and second comparison means to determine whether said matched positions on said randomly numbered grid result in a winning bonus multiplier total, said total is compared to a corresponding payable, and awarding credits if a winning outcome is attained.

### DESCRIPTION OF PREFERRED EMBODIMENTS

In its essence, the device includes a housing, which supports a visual display preferably a video monitor there within. The display may include a window for special messages or for incrementing counting of credits accumulated by the player. The device also includes an LED or other readout for prompting the player and can provide similar verbiage as the window or in lieu thereof, to stimulate the player. The device includes an inlet for the reception therein for coins, currency or the like to auger in the inception of play. A plurality of decision making buttons are located on the face of the apparatus, preferable below the display and a pull handle can be used to initiate play as an alternative to supplement the decision making buttons. A coin hopper or other payment methods, i.e., ticket printers, may be included to effectuate an output of an award due the player. The device may have a top portion with a display thereon having a motif correlative with the game to be played and can include a “pay table”, also know as an award card. A plurality of speakers may be included on the device for aural interaction with the player. The apparatus also includes a processor that coordinates all functions, a random number generator operatively coupled thereto for generating outcomes, a read/write instrumentality thereon, and registers with an input output function to record transfer credits and/or update player status.

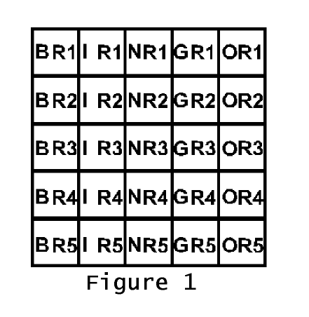

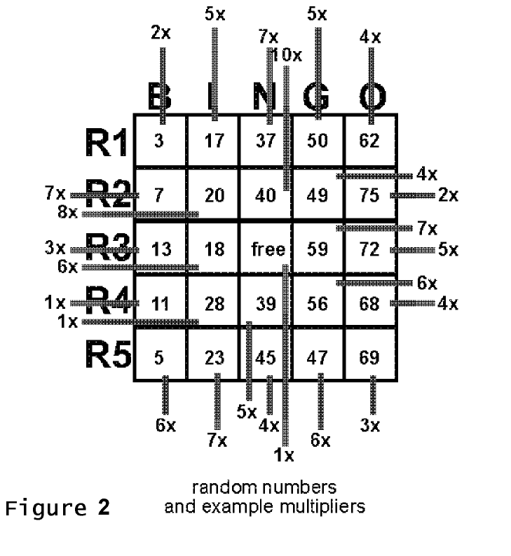

More specifically, greater details with respect to the video display can be explored with respect to the multiplier bonus. In the preferred embodiment, the display features a plurality of randomly numbered positions in a row-and-column (RXC) matrix (FIG. 1). Numbers for play by the device are randomly generated for play on the matrix (FIG. 2). Preferably, the matrix defines a 5×5 array, correlative of BINGO, and above row one depicts the letters “BINGO” defined with positions an alphanumeric display.

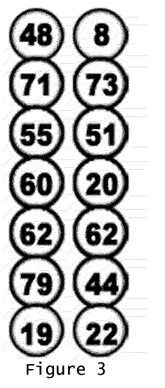

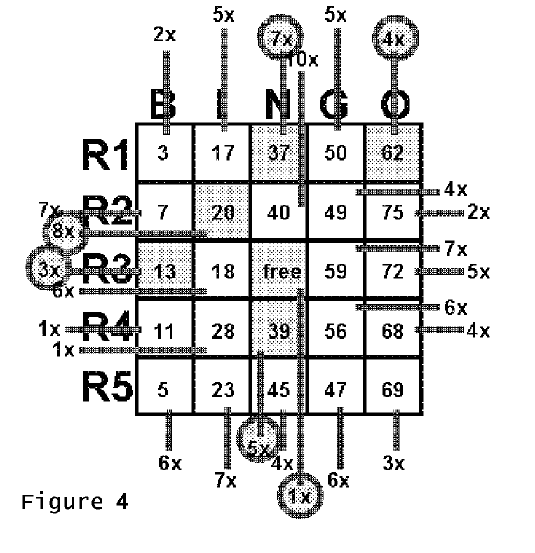

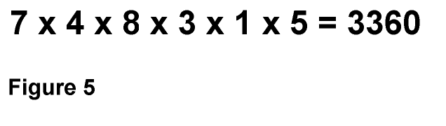

Conducive with the preferred embodiment, the player engages in a gaming proposition for which rewards are given for specific outcomes or specific bonus multiplier totals according to a pay table (FIG. 5). Regardless of whether a reward is given for the primary outcome, the multiplier bonus uses the display, on which a matrix composed of pre-assigned numbered positions is present (FIG. 3). The center position “O” of the matrix is assigned a high-value bonus amount, which is displayed. The first indicia are randomly generated numbers placed in position within the RC matrix (FIG. 2). The second indicia are embodied as a bingo ball having a distinctive numeric or alphanumeric value. Each position on the matrix coincides with only one ball. The second inducia are selected one ball at a time (FIG. 4). Thus, the balls are compared to the numbers on the matrix. If the numbers match, then that position appears in contrasting bold, is highlighted, or is “covered” on the matrix. In addition, each “covered” position is assigned a predetermined multiplier bonus amount. Randomly generated numbers continue to appear on the display until a predetermined number or numbers (second indicia) have been generated.

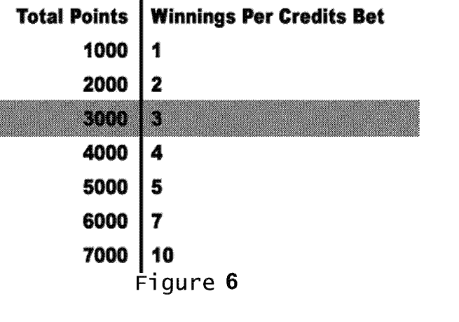

The preferred embodiment contemplates a winning outcome with or without five covered positions along the same row, column, or diagonal of the matrix. Alternatively, a winning outcome could consist only of a matching multiplier bonus value. The multiplier bonus amounts, which correspond to each of the covered spaces (FIG. 3) in that matching outcome, are multiplied together, producing a total multiplier value. This total bonus value (FIG. 6) is compared to the award card for possible winning amounts (FIG. 5). If a winner is made, then the paytable award amount of the bonus multiplier total is won, and is multiplied by the player's initial wager to determine the player's ultimate award due from the bonus game. If the player has not produced a winning outcome on the matrix by the end of the game, the player loses the initial wager and has the option to play the primary game again or to quit and cash out.

The device can be utilized for tournament style play, in which players may compete against each other to acquire a particular type of winning outcome. Such play may also utilize multiple “progressive” awards, with the differing amounts of the awards depending on the amount of the initial wager. That is, one progressive award would be available to players utilizing a maximum wager, while a progressive award of lower value would be available to players utilizing less than a maximum wager.

Thus, awarding of credits may be defined by a plurality of levels of progressive awards, wherein each level is dependent on the number of gaming propositions occurring simultaneously.

Moreover, having thus described the invention, it should be apparent that numerous structural modifications and adaptations may be resorted to without departing from the scope and fair meaning of the instant invention as set forth herein above and as described herein below by the claims.

1. A game card for playing a game of chance, said game card comprising: a matrix of five rows and five columns defining twenty five grid squares adapted for playing the game of bingo; a matrix consisting of a grid known as a bingo card:

2. A method for gaming, the steps including: receiving a wager to enable the gaming device, enabling a primary display, displaying randomly selected first indicia within a row-and-column (RXC) matrix, displaying randomly generated second indicia to be compared to said first indicia, the pre-assignment of multiplier values to each position or “spot” within the row-and-column (RXC) matrix, and leading to a bonus multiplier event, wherein when said randomly generated second indicia match any of the first indicia in any positions on said (RXC) matrix, the matching position values are multiplied and totaled, resulting in a bonus multiplier total, said total (bonus multiplier total) is applied in a second comparison to a predefined corresponding paytable or award card of winning bonus multiplier total amounts, and the awarding credits if a winning outcome is attained.

3. The method of claim 2 including assigning of bonus multiplier values to each spot within the row-and-column (RXC) matrix.

4. The method of claim 2 including correlating bonus multiplier totals to a Pre-assigned award to be used in said awarding of credits.

5. The method of claim 1 including configuring said randomly numbered grid as a 5 times 5 matrix.

6. The method of claim 5 including not assigning the center position of said matrix as a random number, but always considering it to be a matching position.

7. The method of claim 5 including the center position of said matrix is assigned a numbered position.

8. The method of claim 5 including pre-assigning the center position of said matrix a random multiplier bonus adjustment value to be used in said awarding of credits.
A. The multiplier value remains fixed.
B. The multiplier value changes through an external stimuli.

9. The method of claim 2 including awarding of credits by a plurality of levels of progressive awards, wherein each award level is dependent on the success of a plurality of players simultaneously.

10. The device of claim 2 wherein said second indicia are embodied as bingo balls.

11. Assigning a multiplier value to each individual column starting with the “B” row and ending with the “O” row, where each lettered grid square may contain a selected multiplier that would result in a winning.
A. The multiplier value remains fixed.
B. The multiplier value changes through an external stimuli.
